(19) United States
(12) Patent Application Publication
(10) Pub. No.: US 2015/0345676 A1
(43) Pub. Date: Dec. 3, 2015

(54) Pipe Fitting

(71) Applicant: CONNEXT LIMITED, Accington Lancashire (GB)

(72) Inventor: Sergio Patriarca, Turin (IT)

(73) Assignee: CONNEXT LIMITED, Lancashire (GB)

(21) Appl. No.: 14/759,100

(22) PCT Filed: Jan. 3, 2014
(86) PCT No.: PCT/GB2014/050014

§ 371 Date: Jul. 2, 2015

(30) Foreign Application Priority Data
Apr. 1, 2013 (GB) 1300114.4

(51) Int. Cl. F16L 21/00; F16L 21/04

(52) U.S. Cl. CPC F16L 21/007; F16L 21/002; F16L 21/04

(57) ABSTRACT

A pipe fitting for the location of at least one pipeline therewith, said fitting includes a body (5) which supports an annular portion (2) which is movable with respect to the body (5) at the time of installation by operating actuating means (3). A further annular portion (4) is provided to form a fluid tight seal with the pipeline portion. The pipe fitting also includes a number of gripping members (1) at spaced intervals around an annular path and which are located in position in respective recesses formed in the further annular portion (4) and which are movable to an initial gripping position at the time of installation and are then movable to exert and maintain a gripping force on the pipeline once the pipe fitting has been installed.

The invention to which this application relates is to a pipe fitting for use in the joining of an end of at least one pipeline to another pipeline or a pipeline component. The use of fittings of this type is well known and the invention particularly relates to the ability to maintain the integrity of the pipe fitting once formed by allowing the said pipeline end, and portion depending therefrom, to be maintained in the required position within the pipe fitting over time after installation.

The provision of pipelines for a number of services and/or supplies such as water, oil and/or gas, is well known and are an important part of the supply infrastructure. At intervals along the said pipeline, there is a need to join together pipeline sections so as to form the pipeline of the required length and/or to provide certain components, such as valves, to allow the control of the fluid along and/or to and/or from the pipeline. At said locations, the interface between an end of a pipeline section and another pipeline end or component, is required to be formed in a fluid tight manner and also in a mechanically secure manner so as to be able to maintain the said pipeline end in the required position in the fitting over time and hence maintain the integrity of the pipeline as a whole. Furthermore, the pipeline end and the pipe fitting therefore, is required to withstand movement forces which may affect the integrity of the pipe fitting. These can include internal movement forces which may attempt to force the pipeline out of the pipe fitting body, such as, for example, the force of the pressurised fluid moving in a particular direction through the pipeline away from the pipe fitting. External forces can also be a problem and these may be applied to the pipeline as a result of, for example, the settlement of soil around the pipeline if the same is installed underground.

The soil settlement may move the pipeline with respect to the pipe fitting and is known to be particularly, although not necessarily exclusively prevalent at the location of pipeline bends.

Conventionally, it is known that steps can be taken to attempt to allow the pipeline to withstand the movement forces and the effect of the same on removing the pipeline end from the pipe fitting. One known action is to form a concrete block externally of a pipeline bend and which block serves to mechanically locate the pipeline bend so as to prevent or restrict the same, and hence the pipeline end, from moving with respect to the pipe fitting and hence resist the force of the pressurised fluid and/or soil settlement acting on the pipeline. However, this solution is expensive in terms of the pipeline installation as it requires a significantly greater amount of the material adjacent to the pipeline to be excavated, requires additional material in the form of the concrete to be input into the excavated area and also requires the excavated material to be deposited elsewhere.

It is also known to provide gripping means as part of the pipeline fitting, with, typically, a number of gripping means spaced around the inner circumference of the pipeline fitting and which can be selectively moved inwardly such that teeth which are provided on the inner face of the gripping means, engage on the external surface of the pipeline, with a view to gripping the pipeline and restricting the possibility of movement of the pipeline with respect of the fitting. The gripping means teeth are provided as a unitary item in a fixed location with respect to actuating means in the form of a bolt which is typically used to linearly move the gripping means towards and from the external face of the pipeline. This means that once the gripping teeth are set in position and in contact with the pipeline wall at the time of installation, the gripping means teeth are in a fixed, non adjustable and non movable position. This means that once the pipeline has been installed, the pipeline, if provided underground, is surrounded by soil and/or other material such that the gripping means position with regard to the pipeline can no longer be adjusted as the actuating means are no longer accessible outside of the pipe fitting and the portion of the gripping means within the pipe fitting is a unitary member.

In practice, it is found that while the conventional form of the gripping means may have the desired effect at the time of installation by resisting movement of the pipeline away from the pipe fitting, over time, and once the pipe fitting is surrounded by soil and other material, it can be the case that the soil or material will settle with respect to the pipeline and pipe fitting. This settlement exerts a movement force externally on the pipeline which often causes movement of the pipeline with respect to the pipe fitting and movement of the pipeline with regard to the gripping means of the pipe fitting. This in turn, means that the gripping effect on the pipeline with regard to the pipe fitting, is reduced which can cause leakage of the fluid from the pipeline at the fitting and/or can make the pipeline more susceptible to the movement forces applied thereto by the pressurised fluid within the pipeline so that further movement of the pipeline away from the pipe fitting is possible and which can cause further leakage and/or catastrophic failure of the joint formed at the pipe fitting.

The aim of the present invention is therefore to provide a pipe fitting for use in the joining of at least one end of a pipe either to another end of a pipe or to a component and to provide the fitting in a manner which allows improved resistance to movement forces which may be applied to the pipeline and/or fitting once installed so as to maintain the integrity of the joint between the fitting and pipeline over time.

In a first aspect of the invention, there is provided a pipe fitting, said pipe fitting having a body including, at at least one end, a cavity for the reception of a pipeline end and a portion of the pipeline extending therefrom, said pipe fitting including at least one gripping means assembly, and wherein said gripping means assembly includes a member which has a contact portion for exerting a gripping force on the external wall of the pipeline and said member is mounted so as to be movable with respect to said pipe fitting and/or pipeline following installation of the pipe fitting.

In one embodiment the movement of the said member is a pivotal movement.

In one embodiment, the member is movable once and after the pipe fitting has been installed. Furthermore, as the member is located within the pipe fitting so the subsequent movement can be achieved even when the pipe fitting and pipeline are buried in soil and any actuating means are no longer accessible externally of the pipe fitting.

In one embodiment the pipe fitting includes sealing means to provide a substantially fluid tight seal at the fitting

Typically, the movement of the member, occurs following installation of the pipeline and pipe fitting and most typically, is a result of relative movement between the pipeline and the pipe fitting due to either, or both, of internal movement forces on the pipeline caused by the fluid moving through the pipeline and/or external movement forces, such as the settlement of the soil or material in which the pipeline is located after installation.

Typically, a plurality of said members are located at spaced locations around the inner periphery of the cavity of the fitting and each member can be positioned to exert a gripping force on the external wall of the pipeline.

Typically, each of the members is independently moveable with regard to the pipe fitting so as to allow the changes in position which may be caused by the movement of the pipeline with respect to the fitting and which may be greater at certain member locations than at others, to be accommodated.

Typically, the said members are held in position by first and second annular portions of the pipe fitting, the position of at least one of which is adjustable with regard to the pipe fitting body so as to allow the members to be moved into a location in which the same are provided in an initial gripping position on the external wall of the said pipeline portion.

Typically when moving the said annular portion into position actuating means are operated externally of the pipe fitting to move the annular portion with respect to the pipe fitting body. Typically said body includes an inclined surface along which a face of each of the members are slidingly moved into their respective gripping locations with respect to the pipeline wall.

Typically the pipeline contact portion of the gripping member is located on a face which opposes that face of the member which slides along the inclined face of the pipe fitting body.

Typically the said annular portion contacts a side wall of the member which is intermediate the said pipeline and body contacting faces of the member and slides therealong as the annular portion is moved until the contact portion of the member contacts the external wall of the pipeline.

In one embodiment the said other of the annular portions which is used to locate the members is also used to create a seal between the pipeline fitting and the external face of the pipeline. Typically the said members are respectively located in recesses formed in the said annular portion which creates the seal.

In one embodiment the members are formed from a metal such as gun metal or martensitic stainless steel.

In one embodiment there is provided a plurality of sets of members, a first set provided to contact with a first pipeline portion and a second set to contact with a second pipeline portion and thereby form a join between the said pipeline portions.

A pipeline can therefore be created using at least two pipeline sections joined together by a pipe fitting as herein described.

In a further aspect of the invention, there is provided a gripping means for use in a pipe fitting, said gripping means including a member with a contact portion for exerting a gripping force on the external wall of a pipeline, and locating means on which the said member is mounted and wherein said member is moved to an held in an initial gripping position by movement of said locating means in order to exert a gripping force on the said external wall of the pipeline at the time of installation and is thereafter moveable with respect to the location means whilst retaining a gripping force on the external wall of the pipeline.

Typically the locating means is itself adjustable with respect to a body of the fitting at east at the time of installation.

In a further aspect of the invention there is provided a pipeline with at least one fitting as hereinbefore described.

The invention is now described in more detail with reference to the accompanying drawings wherein;

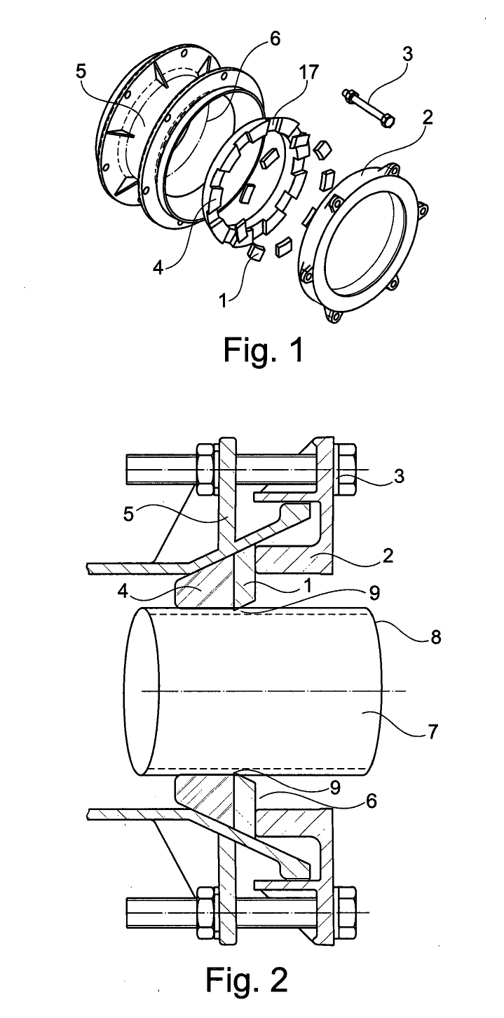

FIG. 1 illustrates the component parts of one end of a pipe fitting in accordance with one embodiment of the invention;

FIG. 2 illustrates a cross sectional elevation of the end of a pipe fitting in accordance with one embodiment of the invention;

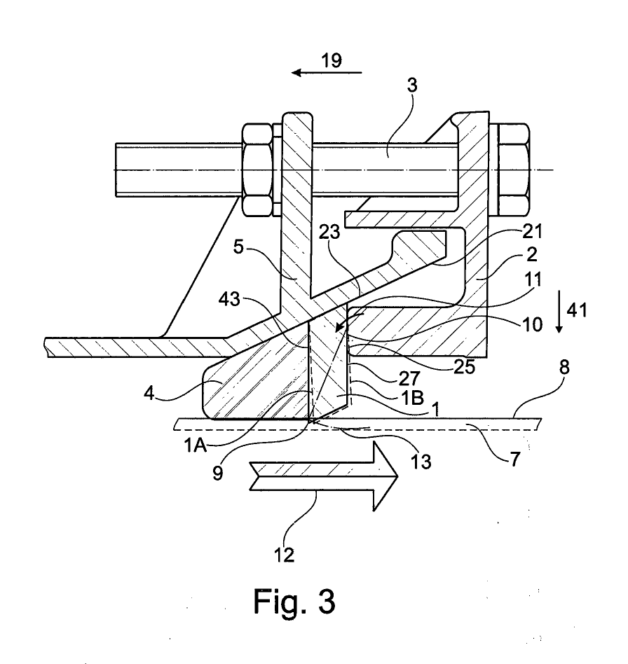

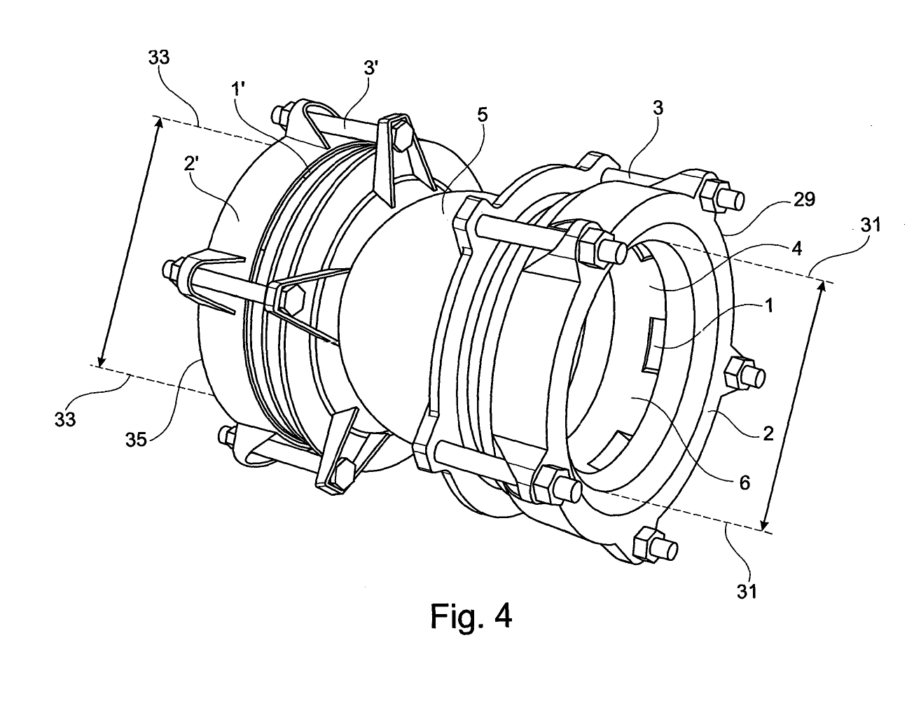

FIG. 3 illustrates a cross section of one side of the end of the pipe fitting in conjunction with a portion of a pipeline;

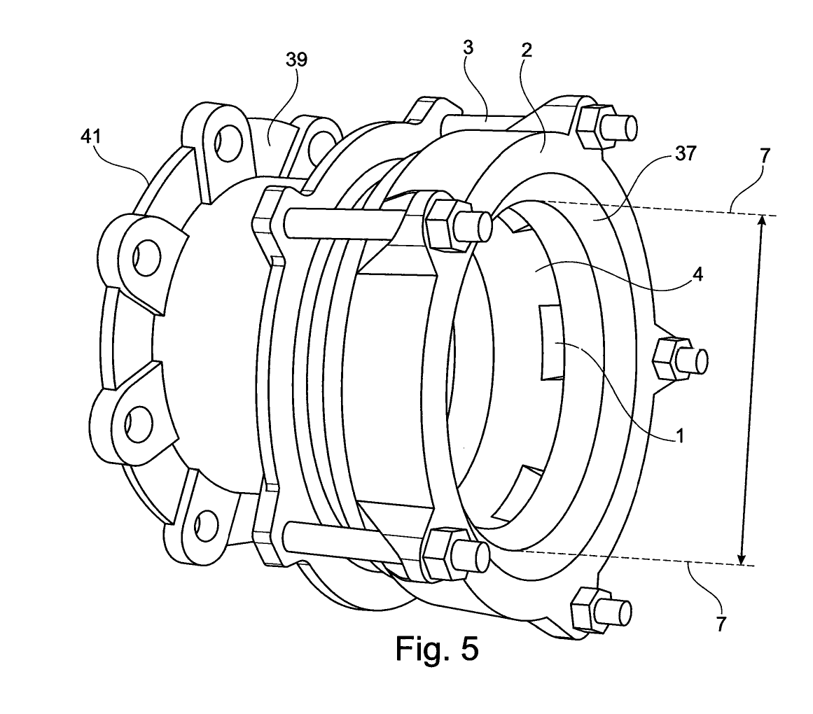

FIG. 4 illustrates a pipe fitting in accordance with one embodiment of the invention for use in joining together ends of first and second pipelines; and

FIG. 5 illustrates a pipe fitting in accordance with another embodiment of the invention for use in joining an end of a pipeline to a pipeline component such as a valve.

Referring firstly to FIG. 1 there is shown the components of one end of a pipe fitting which can be formed according to one embodiment of the invention.

The components include a body 5 which is generally cylindrical in structure. The body supports an end ring or annular portion 2 and the end ring portion 2 and body can be moved with respect to each other to form the fitting at the time of installation by tightening actuating means in the form of bolts 3 which are provided at spaced intervals as shown. A further annular portion in the form of a rubber gasket seal 4 is provided to form a fluid tight seal with the pipeline portion located within the cavity 6 defined within the pipe fitting.

In accordance with the invention the fitting also includes a number of members 1 at spaced intervals around an annular path and which are located in position in respective recesses 17 formed in the annular portion 4.

FIG. 2 illustrates a cross sectional elevation of the assembled end of a pipe fitting using the components of FIG. 1. The pipe fitting end is shown with a portion of a pipeline section 7 located within the cavity 6 of the fitting and illustrates the manner in which the annular portion 4 contacts the external wall 8 of the pipeline in order to provide the pipe fitting with a fluid tight seal. Also shown is that the gripping members 1 have a contact portion 9 to contact with and grip the external wall 8 of the pipeline so as to exert a gripping force on the pipeline and retain the pipeline portion 7 in the desired position in the cavity 6 of the pipe fitting.

The installation of the fitting is now described with reference to FIG. 3. The annular portion 2 is moved towards the body 5 of the pipe fitting in the direction indicated by arrow 19 by the tightening of the bolts 3. As this occurs the face 21 of the gripping member 1 slides along the inclined face 23 of the body 5 and the contact face 25 of the annular portion 2 slides down the side wall 27 of the gripping member 1 as indicated by arrow 41. This movement causes each of the gripping members to be moved such that the contact portion 9 gets closer to the external wall 8 of the pipeline 7 until contact is made and a gripping force is exerted on the pipeline wall. When in position, the gripping member is also located in the respective recess 17 provided in the annular sealing portion 4 and the face 43 of the member typically contacts with the annular sealing portion 4.

Thus, once installed, the members in the set exert a gripping force on the external wall of the pipeline 7 via the contact portions 9. Following installation, and typically over a period of time of days, weeks, months and/or even years, external and/or internal forces applied to the pipeline and/or pipe fitting can cause relative movement between the pipeline and the pipe fitting. These forces, without the pipe fitting of the current invention, would reduce the gripping effect on the pipeline position and allow potential failure of the pipe fitting. However, in accordance with the invention, the dimensions of the members with respect to the adjacent components of the body, and annular portions are such that each of the members 1 is pivotally movable to a limited extent about a respective axis 10 such that the attempted movement of the pipeline in the direction 12 shown in FIG. 3 causes the member 1 to be movable as illustrated by arrow 11 and, in turn, the contact portion 9, which effectively is “biting” into the pipeline wall moves, and continues to exert, and possibly increase, the gripping force on the pipeline so as to resist the external or internal movement forces applied thereto.

As shown in FIG. 3 as the gripping members are pivotally movable, any movement of the pipeline in the direction 12 causes the gripping members to move from the initial gripping position 1A to the position 1B as shown in broken lines and the contact portion 9 to move about the arc 13 to thereby maintain and increase the gripping action of the members 1 on the pipeline external face and thereby prevent the pulling out of the pipeline from the pipe fitting and prevent or reduce the risk of failure of the same.

Thus, in accordance with the invention, any tendency for the pipe to move acts to drag the members 1 to increase the gripping effect on the pipeline and hence oppose the movement force on the pipeline until an equilibrium is reached.

Referring now to FIGS. 4 and 5, in FIG. 4 there is illustrated a complete pipe fitting in accordance with one embodiment of the invention in which an end of a first pipeline 31, illustrated in broken lines, can be received within cavity 6 at a first end 29 of the fitting and an end of a second pipeline 33 can be received in cavity 6 at the second end 35 of the fitting. In this embodiment the fitting includes a body 5 and at end 29 a first gripping means assembly including annular portion 2, annular portion 4 and bolts 3 and a set of members 1 and at end 35 a second gripping means assembly of annular portion 2′, annular portion 4′ (not shown) bolts 3′ and members 1′. At each end the installation and subsequent use of each of the set of components is as described with regard to FIGS. 1-3.

In FIG. 5 the fitting is used to connect an end of a pipeline 7 illustrated in broken lines at end 37 to a component, such as a valve, (not shown) via a flange 39 at the opposing end 41 of the fitting. In this case only one gripping means assembly of annular portion 2, annular portion 4, bolts 3 and members 1 are required to be provided at the end 37 and again are installed and operate as described with regard to FIGS. 1-3.

1. A pipe fitting, said pipe fitting having a body including, at least one end, a cavity for the reception of a pipeline end and a portion of the pipeline extending therefrom, said pipe fitting including at least one gripping assembly, and wherein said at least one gripping assembly includes a member which has a contact portion for exerting a gripping force on an external wall of the pipeline and wherein said member is mounted so as to be pivotally movable with respect to said pipe fitting and/or pipeline following installation of the pipe fitting, so as to continue to exert the gripping force on the pipeline upon the occurrence of relative movement between the pipeline and pipe fitting following installation.

2. A pipe fitting according to claim 1 wherein a plurality of said members are located at spaced locations around the inner periphery of the cavity of the fitting and the members are positioned to exert a gripping force on the external wall of the pipeline.

3. A pipe fitting according to claim 2 wherein the said members are held in position by an annular portion of the pipe fitting, the position of which is movable with respect to the pipe fitting body at the time of installation.

4. A pipe fitting according to claim 3 wherein the members are located in an initial gripping position on the external wall of the said pipeline portion by movement of the said movable annular portion.

5. A pipe fitting according to claim 4 wherein an actuating member is provided on the external face of the pipe fitting to allow the movable annular portion to be moved with respect to the pipe fitting body.

6. A pipe fitting according to claim 5 wherein the body includes an inclined surface along which a face of the members are slidingly moved into the initial gripping position.

7. A pipe fitting according to claim 6 wherein the annular portion contacts a side wall of the member and slides therealong as the said annular portion is moved until the contact portion of the gripping member contacts the external wall of the pipeline.

8. A pipe fitting according to claim 3 wherein a further annular portion is provided to form a seal between the pipe fitting and the external face of the pipeline and is also used to locate the members.

9. (canceled)

10. A pipe fitting according to claim 8 wherein the said members are respectively located in recesses formed in the further annular portion and are independently moveable after installation.

11. (canceled)

12. (canceled)

13. (canceled)

14. A pipe fitting according to claim 1 wherein the pipeline contact portion of the member is located on a face opposing that which slides along an inclined surface of the pipe fitting body when the member is moved to an initial gripping position.

15. A pipe fitting according to claim 1 wherein said pipe fitting includes a plurality of sets of members, a first set provided to contact with a first pipeline portion and a second set to contact with a second pipeline portion and thereby form a joint between the said pipeline portions.

16. A pipeline formed from at least two pipeline portions joined together using a pipe fitting as defined in claim 1.

17. A gripping assembly for use in a pipe fitting, said gripping assembly including a member with a contact portion for exerting a gripping force on an external wall of a pipeline, and a locating member on which the said member is mounted said member movable to, and held in, an initial gripping position by movement of said locating member in order to exert a gripping force on the said external wall of the pipeline at the time of installation and wherein said member is thereafter pivotally moveable with respect to the location member whilst retaining a gripping force on the external wall of the pipeline, upon the occurrence of relative movement between the pipeline and pipe fitting following installation.

18. (canceled)

19. A method of joining an end of a pipeline to another end of a pipeline or a pipeline component using a pipe fitting, said method comprising the steps of positioning the pipeline end into a cavity in the pipe fitting such that a portion of the pipeline extending from the said pipeline end is located within the cavity, providing a fluid seal in the cavity between the pipeline and the pipe fitting, providing at least one gripping assembly in the pipe fitting, said gripping assembly including a member and moving, if required, via actuation member, an annular portion of the gripping assembly with respect to the pipe fitting body to move the said member into contact with an external face of the said portion of the pipeline, and wherein locating the member with a further annular portion of the pipe fitting to maintain the member in contact with the external face of the said portion of the pipeline, wherein said member is pivotally movable with respect to the said annular portions to allow relative movement between the pipeline and the pipe fitting to be accommodated after installation whilst maintaining the integrity of the join between the pipe fitting and said pipeline.

20. A method according to claim 19 wherein the steps are repeated for a further set of members used to connect a second pipeline end and portion depending therefrom in the pipe fitting.
